(19) United States
(12) Patent Application Publication
(10) Pub. No.: US 2024/0103505 A1
(43) Pub. Date: Mar. 28, 2024

(54) CALCULATION SYSTEM AND CALCULATION METHOD

(71) Applicant: HITACHI, LTD., Tokyo (JP)

(72) Inventors: Keiro Muro, Tokyo (JP); Yoshinari Hori, Tokyo (JP)

(73) Assignee: HITACHI, LTD., Tokyo (JP)

(21) Appl. No.: 18/465,655

(22) Filed: Sep. 12, 2023

(30) Foreign Application Priority Data
Sep. 22, 2022 (JP) 2022-151877

(51) Int. Cl. G05B 19/418

(52) U.S. Cl. CPC G05B 19/41885

(57) ABSTRACT

A calculation system that, in an environment based on a digital twin to which the assets are hierarchically connected, executes a simulation regarding the assets on the basis of an output specification regarding a sampling rate and target accuracy that is target accuracy of calculation processing, the calculation system includes a requirement condition calculation unit configured to calculate an output specification to be required for a downstream hierarchy, and a requirement adjustment unit configured to adjust the output specification of a hierarchy that receives a requirement on the basis of the requirement received from the downstream hierarchy, and the requirement condition calculation unit calculates an output specification to be required for an upstream hierarchy on the basis of the output specification adjusted by the requirement adjustment unit.

### BACKGROUND OF THE INVENTION

### 1. Field of the Invention

The present invention relates to a calculation system and a calculation method.

### 2. Description of the Related Art

From the viewpoint of digital transformation (DX), a technology called a digital twin that captures various events, states, and environments in a real space with data and constructs an environment under the same conditions on a digital space is known. For example, a system that constructs a virtual space in which respective facilities of a factory are set as an asset group, updates a state of the asset group in the virtual space on the basis of acquired data of the facilities, and grasps a state of the real world in real time, can be considered.

Here, J P 2020-504382 A describes processing of computer hardware metrics closely related to each other. Further, J P 2020-504382 A describes that “relates to a computer-implemented system and method for predicting needs for network resources and/or infrastructures for an enterprise computer system employing a network server to host resources (applications, data, etc.) requested by a network user. Based on the prediction, the network resources may be scaled or provisioned accordingly. In other words, for example, a state of the network server can be dynamically adjusted to meet required needs of the user while reducing an excessive capacity. The prediction techniques of the present invention are also applicable to cloud computing environments. Based on the prediction, a cloud server pool is dynamically scaled, so that a scale of a system meets changing requirements and avoids wasting resources when a load of the system is low”.

JP 2021-39681 A describes a technique capable of performing processing without affecting vehicle operation. JP 2021-39681 A discloses a technique of performing different processing in communication between a wireless communication module and an in-vehicle device among “normal time”, “high load of the gateway 18 or high load of the bus 22”, and “high load of the in-vehicle device 12”.

### SUMMARY OF THE INVENTION

For example, in a case where an environment using a graph of hierarchical assets as a model is constructed, a calculation amount may increase explosively. However, it is considered that neither JP 2020-504382 A nor JP 2021-39681 A discloses a technique for favorably reducing a calculation load due to an increase in a calculation amount in such an environment.

It is therefore an object of the present invention to provide a calculation system and a calculation method capable of appropriately reducing a calculation load from the viewpoint of a sampling rate and accuracy in an environment using a graph of hierarchical assets as a model and capable of contributing from an economic viewpoint.

According to a first aspect of the present invention, the following calculation system is provided. This calculation system is a system that, in an environment based on a digital twin to which assets are hierarchically connected, executes a simulation regarding the assets on the basis of an output specification regarding a sampling rate and target accuracy that is target accuracy of calculation processing. The calculation system includes a requirement condition calculation unit and a requirement adjustment unit. The requirement condition calculation unit calculates an output specification to be required for a downstream hierarchy. The requirement adjustment unit adjusts an output specification of a hierarchy that receives a requirement on the basis of the requirement received from the downstream hierarchy. Then, the requirement condition calculation unit calculates an output specification to be required for an upstream hierarchy on the basis of the output specification adjusted by the requirement adjustment unit.

According to a second aspect of the present invention, the following calculation method is provided. This calculation method is a method of, in an environment based on a digital twin to which assets are hierarchically connected, executing a simulation regarding the assets on the basis of an output specification regarding a sampling rate and target accuracy that is target accuracy of calculation processing. This calculation method is a method to be executed using a processor and a storage that stores an output specification. The processor calculates an output specification to be required for a downstream hierarchy, adjusts an output specification of a hierarchy that receives a requirement on the basis of the requirement received from the downstream hierarchy and calculates an output specification to be required for an upstream hierarchy on the basis of the adjusted output specification.

According to the present invention, it is possible provide a calculation system and a calculation method capable of appropriately reducing a calculation load from the viewpoint of a sampling rate and accuracy in an environment using a graph of hierarchical assets as a model and capable of contributing the optimization of processes and resources (for example, within factory production or an manufacturing system monitoring and control) from an economic viewpoint. Note that problems, configurations, and effects other than those described above will be clarified by the following description of embodiments for carrying out the invention.

### BRIEF DESCRIPTION OF THE DRAWINGS

FIG. 1 is a view for explaining outline of a calculation system;

FIG. 2 is a view illustrating an example of a hardware configuration of the calculation system;

FIG. 3 is a view illustrating an example of a data structure that stores information of a simulation model;

FIG. 4 is a view illustrating an example of the data structure that stores information of the simulation model;

FIG. 5 is a view illustrating an example of the data structure that stores information of the simulation model;

FIG. 6 is a view for explaining an example of an aspect of simulation;

FIG. 7 is a view illustrating an example of a data structure of a process model;

FIG. 8 is a view illustrating an example of an output specification;

FIG. 9 is a view illustrating an example of an input port;

FIG. 10 is a view illustrating an example of an output port;

FIG. 11 is a view illustrating an example of a SIM list;

FIG. 12 is a view for explaining an example of outline of calculation processing according to the process model in simulation execution;

FIG. 13 is a view illustrating an example of input/output of the process model;

FIG. 14 is a view for specifically describing data to be input/output;

FIG. 15 is a view illustrating an example of input/output of the process model;

FIG. 16 is a view illustrating an example of input/output of a data source;

FIG. 17 is a view illustrating an example of input/output of a data sink;

FIG. 18 is a view illustrating an example of data input/output processing in the data source, the process model, and the data sink;

FIG. 19 is a flowchart for explaining an example of processing of outputting a delivery reservation;

FIG. 20 is a flowchart for explaining an example of processing of outputting a delivery cancellation;

FIG. 21 is a flowchart for explaining an example of processing of outputting a data event;

FIG. 22 is a flowchart for explaining an example of processing of outputting a requirement notification;

FIG. 23 is a flowchart for explaining an example of processing of outputting sensor data;

FIG. 24 is a flowchart for explaining an example of processing of outputting a requirement relaxation request;

FIG. 25 is a flowchart for explaining an example of processing of outputting a requirement notification by using a quality compromise condition table;

FIG. 26 is a view for explaining an example of a data structure of the quality compromise condition table;

FIG. 27 is a view for explaining an example of processing of changing an output specification; and

FIG. 28 is a view for explaining an example of an image to be output to a GUI.

### DESCRIPTION OF THE PREFERRED EMBODIMENTS

An embodiment of the present invention will be described below with reference to the accompanying drawings. The embodiment is an example for describing the present invention, and omission and simplification are appropriately made for clarity of description. The present invention can be implemented in various other forms. Unless otherwise specified, each component may be singular or plural.

Positions, sizes, shapes, ranges, and the like, of the components illustrated in the drawings may not represent actual positions, sizes, shapes, ranges, and the like, in order to facilitate understanding of the invention. Thus, the present invention is not necessarily limited to the position, size, shape, range, and the like, disclosed in the drawings.

Examples of various kinds of information may be described in terms of expressions such as “table”, “list”, and “queue”, but various kinds of information may be expressed in a data structure other than these. For example, various kinds of information such as “XX table”, “XX list”, and “XX queue” may be “XX information”. In describing identification information, expressions such as “identification information”, “identifier” “name” “ID” and “number” are used, but these can be replaced with each other.

In a case where there is a plurality of components having the same or similar functions, the same reference numerals may be attached with different subscripts for description. In addition, in a case where it is not necessary to distinguish the plurality of components, description may be made by omitting the subscript.

In the embodiment, processing to be performed by executing a program may be described. Here, a computer executes a program by a processor (for example, CPU, GPU), and performs processing defined by the program using a storage resource (for example, a memory), an interface device (for example, a communication port), and the like. Thus, the subject of the processing to be performed by executing the program may be a processor. Similarly, the subject of the processing to be performed by executing the program may be a controller, a device, a system, a computer, or a node having a processor. The subject of the processing to be performed by executing the program only requires to be a calculation unit and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computer from a program source. The program source may be, for example, a program distribution server or a computer-readable storage medium. In a case where the program source is a program distribution server, the program distribution server may include a processor and a storage resource that stores a distribution target program, and the processor of the program distribution server may distribute the distribution target program to another computer. In the embodiment, two or more programs may be implemented as one program, or one program may be implemented as two or more programs.

A calculation system of the present embodiment will be described with reference to the drawings. This calculation system is a system in which a digital twin technology is implemented. In the present embodiment, as an example, a system capable of constructing a virtual space regarding each facility of a factory, updating states of assets in the virtual space on the basis of acquired data, and grasping a state of the real world in real time will be described.

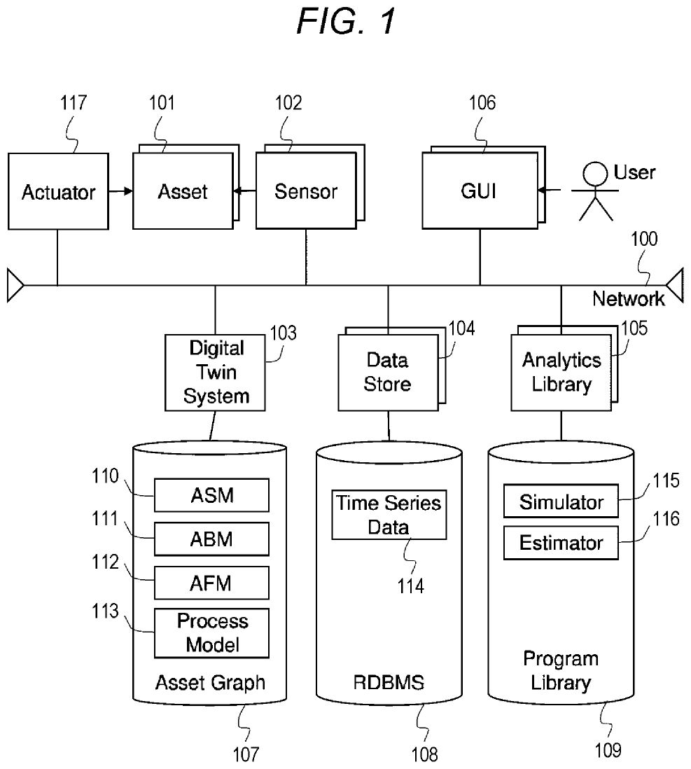

First, outline of the calculation system will be described with reference to FIG. 1. In the calculation system, a digital twin system 103 that updates states of assets 101 on the basis of sensor data from sensors 102 that acquire data of facilities of a factory and implements a digital twin is mounted. The digital twin system 103 may directly acquire data from an actuator 117 (facility of the factory) to update the states of the assets 101.

Here, an asset graph 107 stores data defining a state of each asset in the digital twin system 103. In the present embodiment, the calculation system sets an asset group defined by a directed graph including assets of three or more hierarchies as a processing target. Describing an example of a connection relationship between assets, in a case where a pump is a target as a facility of the factory, an asset group to be processed by the calculation system may include, for example, an asset indicating a pump, an asset indicating a motor serving as a drive source of the pump, and an asset indicating an impeller to be rotated by the motor. Then, for example, the asset of the pump, the asset of the motor, and the asset of the impeller may be arranged in this order from an upstream hierarchy to a downstream hierarchy.

Furthermore, in the present embodiment, the asset graph 107 stores an ASM 110, an ABM 111, and an AFM 112 as data related to a simulation model at the time of executing a simulation based on the states of the assets. In addition, the asset graph 107 stores a process model 113 referred to in the calculation processing. Note that the data of (110 to 113) will be described in detail later.

Furthermore, the calculation system may be connected to a data store 104 in which a RDBMS 108 (software called relational database management system) is implemented. Then, appropriate data such as time series data 114 related to a simulation result may be accumulated in the data store 104.

Further, the calculation system may also be connected to an analytics library 105. The analytics library 105 is a library in which various kinds of data to be used for data analysis are collected. The analytics library 105 is connected to a program library 109 which is a library of programs, and the program library 109 stores, for example, a simulator 115 to be used to execute a simulation and an estimator 116 to be used to calculate cost.

In this example, the sensor 102, the digital twin system 103, the data store 104, the analytics library 105, and the actuator 117 described above are connected by a network 100. Then, the calculation system appropriately inputs and outputs data via the network 100. The calculation system may accumulate data in the data store 104 via the network 100 or may download data from the analytics library 105 and perform processing. Furthermore, a user can access the digital twin system 103, the data store 104, and the analytics library 105 using a GUI 106 (graphics user interface) connected to the network 100 and can input and output various kinds of information.

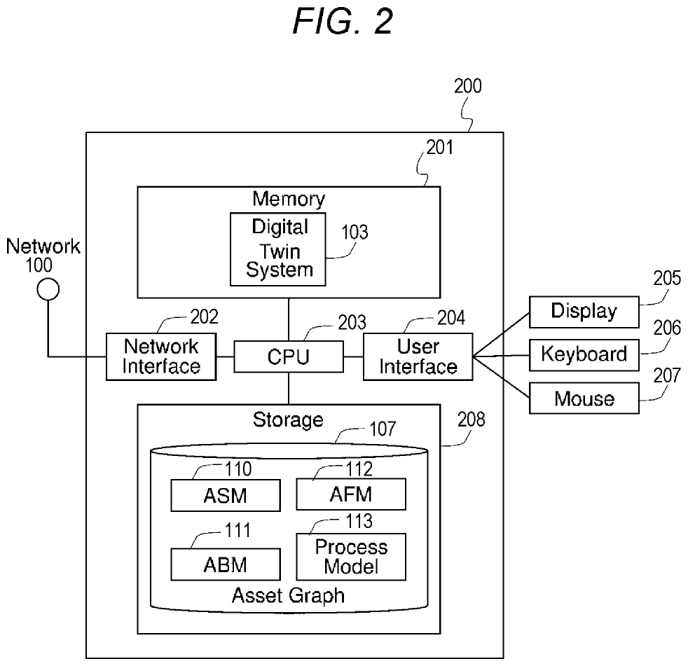

Next, an example of a hardware configuration of the calculation system will be described with reference to FIG. 2.

In this example, the calculation system 200 includes a memory 201, a network interface 202, a CPU 203, a user interface 204, and a storage 208. The network interface 202 is an interface connected to the network 100. The user interface 204 is an interface connected to a device to be used by the user, such as a display 205, a keyboard 206, and a mouse 207. The GUI 106 described above can be implemented by these components (205 to 207) as an example.

The CPU 203 is a subject that processes a program in the calculation system 200 and appropriately performs processing using the memory 201, the network interface 202, the user interface 204, and the storage 208. In the present embodiment, a program for implementing the digital twin system 103 and data such as the asset graph 107 are appropriately stored in the storage 208. The CPU 203 can implement the digital twin system 103 by reading data acquired using the network interface 202 and data in the storage 208 into the memory 201 and performing processing.

Note that the data store 104 and the analytics library 105 described above may be implemented by the storage 208. On the other hand, the data store 104 and the analytics library 105 may be implemented by a computer, or the like, appropriately configured outside.

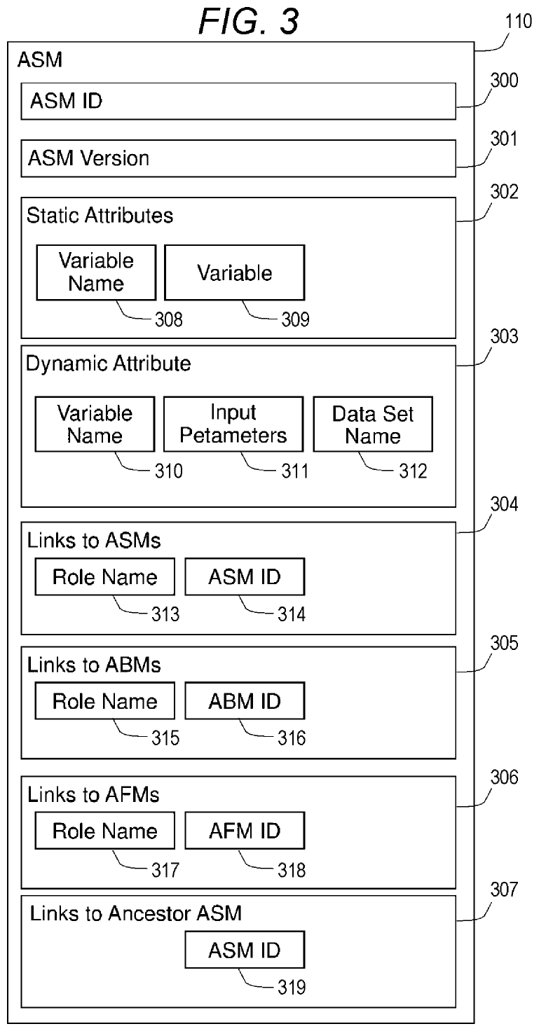

Next, a simulation model to be used for a simulation executable by the calculation system will be described with reference to FIGS. 3 to 6. Note that, as an example, the simulation model can be a model that predicts whether or not an appropriate result is output according to the input.

First, an example of the ASM will be described with reference to FIG. 3. The ASM 110 stores basic information of the simulation model. The ASM 300 stores ID information 300 of the simulation model and version information 301 of the simulation model.

Further, the ASM 110 also stores static attribute information 302. The static attribute information 302 stores information regarding a static attribute of the simulation model specified by the ID information 301 and the version information 302. Here, the static attribute stores data whose state is maintained throughout execution of the specified simulation model. In this example, the static attribute information 302 includes a variable name 308 and a variable 309.

Further, the ASM 110 also stores dynamic attribute information 303. The dynamic attribute information 303 stores information regarding a dynamic attribute of the specified simulation model. Here, the dynamic attribute stores information that is repeatedly generated and discarded during execution of the specified simulation model. In this example, the dynamic attribute information 303 includes a variable name 310, an input parameter 311, and a data set name 312.

Here, the input parameter 311 indicates a parameter to be input to the variable indicated by the variable name 310. In a case where a variable is treated as a data set, the data set name 312 stores the variable name.

In addition, the ASM 110 stores ASM link information 304, ABM link information 305, AFM link information 306, and ancestor ASM link information 307. These pieces of information (304 to 307) are information in which information related to the simulation model specified by the ID information 300 of the ASM is appropriately summarized.

The ASM link information 304 stores a role name 313 and ID information 314 of the ASM. These pieces of data (313, 314) store information of the simulation model summarized from the viewpoint of the ASM for the specified simulation model.

The ABM link information 305 stores a role name 315 and ID information 316 of the ABM. These pieces of data (315, 316) store information of the simulation model summarized from the viewpoint of ABM to be described in detail later for the specified simulation model.

The AFM link information 306 stores a roll name 317 and ID information 318 of the AFM. These pieces of data (317, 318) store information of the simulation model summarized from the viewpoint of the AFM to be described in detail later for the specified simulation model.

The ancestor ASM link information 307 stores information of the simulation model summarized from the viewpoint of a difference in version for the specified simulation model. The ancestor ASM link information 307 stores ID information 319 of the ASM as this information.

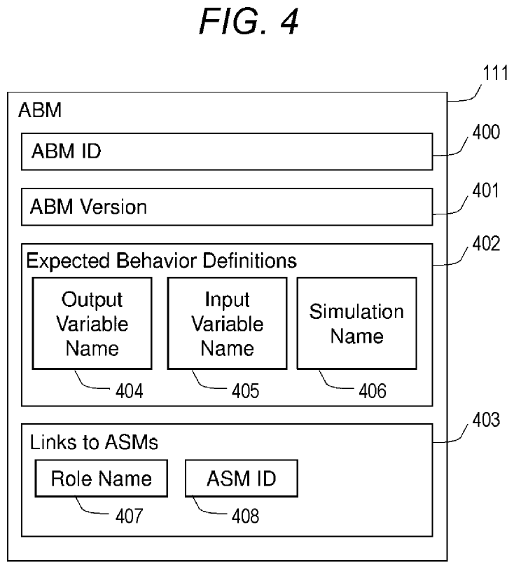

Next, an example of the ABM will be described with reference to FIG. 4. The ABM 111 stores information regarding operation of the simulation. The ABM 111 stores ID information 400 of the simulation model and version information 401 of the simulation model.

The ABM 111 includes a predictive operation definition 402. The predictive operation definition 402 stores information on predictive operation by the simulation model specified by the ID information 400 and the version information 401. Here, the predictive operation definition 402 stores an output variable name 404, an input variable name 405, and a simulation name 406.

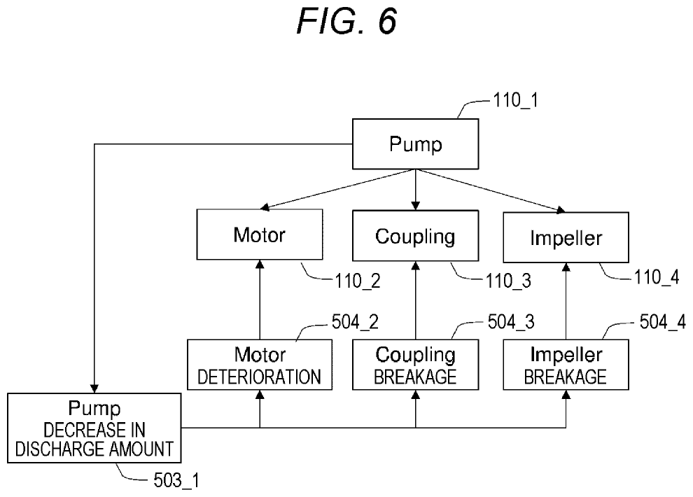

The output variable name 404 indicates a name of a variable that outputs a value in execution of the specified simulation model. The input variable name 405 indicates a name of a variable that inputs a value in execution of the specified simulation model. For example, in the description of FIG. 6 to be described later, the output variable name 404 corresponds to an upstream asset (for example, a pump), and the input variable name 405 corresponds to a downstream asset (for example, a motor, a coupling, and an impeller). The simulation name 406 stores a name of the simulation to be executed.

The ABM 111 stores ASM link information 403. The ASM link information 403 stores a role name 407 and ID information 408 of the ASM. These pieces of data (407, 408) store information of the simulation model summarized from the viewpoint of the ASM for the specified simulation model.

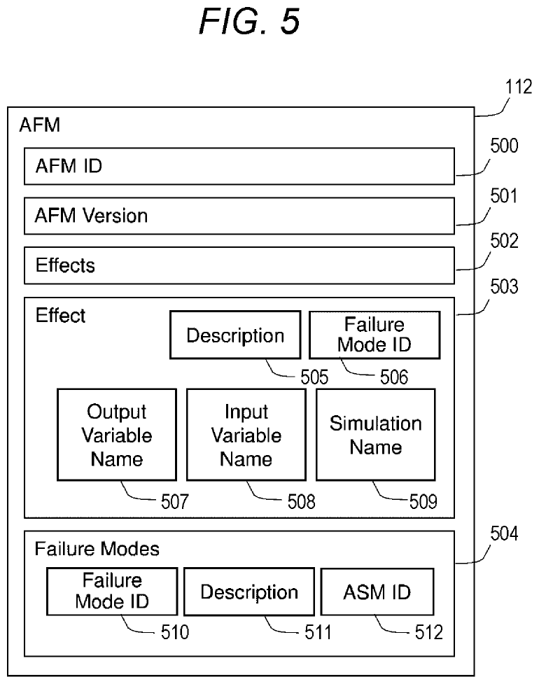

Next, an example of the AFM will be described with reference to FIG. 5. The AFM 112 stores information of the simulation model in which a defect (abnormality) has occurred in the simulation result. The AFM 112 stores ID information 500 of the simulation model and version information 501 of the simulation model.

The AFM 112 stores an effect (reason) 502. The effect (reason) 502 stores a reason (information indicating a failure, deterioration, and the like), of the defect in the specified simulation result.

The AFM 112 stores an effect (detail) 503. The effect (detail) 503 indicates specific content of the effect (reason) described above. The effect (detail) 503 stores description 505, ID information 506 of a failure mode, an output variable name 507, an input variable name 508, and a simulation name 509.

The description 505 stores information related to description of a reason why the simulation has failed. For example, in a case of a failure in a simulation for predicting whether a total discharge amount reaches a predetermined total amount after a predetermined period by driving of the pump, the description 505 stores, for example, information describing that the failure is caused by a decrease in the discharge amount of the pump.

The ID information 506 of the failure mode stores information for identifying a reason why the simulation has failed. Note that different IDs are assigned for each failure reason.

The output variable name 507 indicates a variable name of a variable that outputs a value in the specified simulation model, and the input variable name 508 indicates a variable name of a variable input by the value in the specified simulation model. The simulation name 509 indicates a name of the executed simulation.

The failure mode 504 is information appropriately summarized from information of a simulation model related to the simulation model specified by the ID information 500 and the version information 501 of the AFM. The failure mode 504 stores ID information 510 of the failure mode, a description 511 thereof, and ID information 512 of the ASM.

Next, an example of an aspect of a simulation to be executed by the calculation system will be described with reference to FIG. 6. FIG. 6 is an example of a simulation for predicting whether the total discharge amount reaches equal to or greater than a predetermined amount after a predetermined period by driving of the pump. In this processing, the calculation system can appropriately use the analytics library 105 (for example, the simulator 115).

In this simulation, there are assets of a pump (110_1), a motor (110_2), a coupling (110_3), and an impeller (110_4) as dynamic variable names, and the pump is an upstream asset and the others are downstream assets in a connection relationship.

In the simulation, a state of the asset of the pump is updated on the basis of a value (for example, a sensor value) input to the variable name of the pump, and as a result, it is predicted that the discharge amount of the pump decreases (503_1) and does not reach the predetermined amount. Then, from the variable name of the pump, a value indicating the decrease in the discharge amount is output to the variable name of each of the motor, the coupling, and the impeller.

Then, the value indicating the decrease in the discharge amount is input to the downstream variable name, and deterioration of the motor (504_2), breakage of the coupling (504_3), and breakage of the impeller (504_4) are predicted. Note that information indicating a result (abnormality) of this simulation is appropriately stored in the AFM 112.

Meanwhile, in the digital twin, in a case where the connection relationship of assets becomes complicated (for example, there is a connection relationship of three or more hierarchies), it is also conceivable that the overall calculation load explosively increases. Thus, a technique for reducing the calculation load will be described below. In the present embodiment, this technology is implemented by using the above-described process model for each asset.

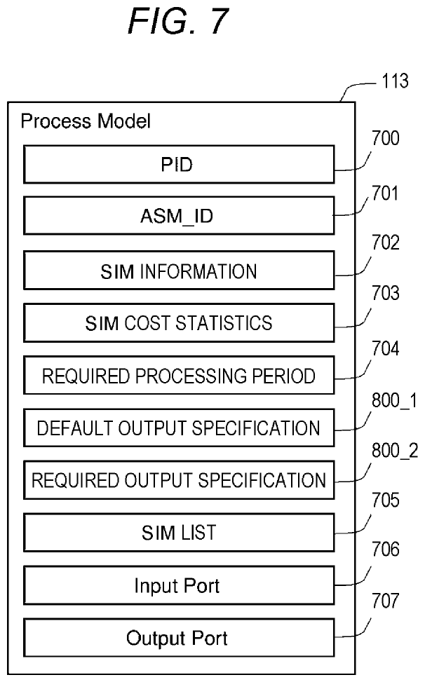

A data structure of the process model will be described with reference to FIGS. 7 to 11. The process model is a model related to an output specification in calculation processing by a processor (in the present embodiment, the CPU 203). In addition, data is input/output between the process models 113.

As illustrated in FIG. 7, the process model 113 stores a PID 700, an ASM_ID 701, SIM information 702, SIM cost statistics 703, a required processing period 704, a default output specification 800_1, a required output specification 800_2, a SIM list 705, an input port 706, and an output port 707.

The PID 700 stores identification information of the process model 113. Different values are stored according to the process model 113 to be applied to the asset.

The ASM_ID 701 stores the ID information 300 of the ASM of a simulation model to which the process model is to be applied.

The SIM information 702 stores appropriate information of the simulation model specified by the ASM_ID 701. The SIM cost statistics 703 stores statistics of cost (calculation cost) necessary for execution of the simulation model specified by the ASM_ID 701. The required processing period 704 stores a processing period to be required for execution of the simulation model specified by the ASM_ID 701. Note that values such as a cost value are calculated by using the estimator 116 as an example.

The default output specification 800_1 stores the output specification at the time of default (in other words, in a case where a requirement is not received from another process model). The required output specification 800_2 stores an output specification required from another process model.

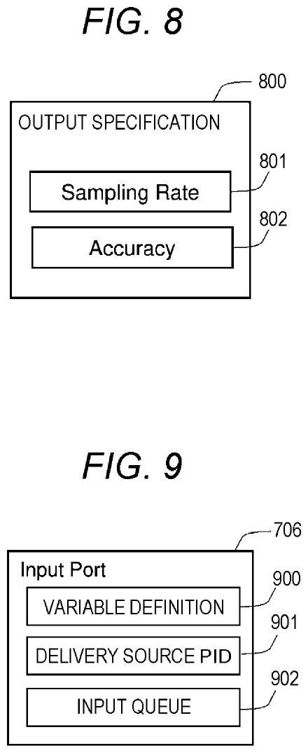

Here, a data structure of the output specification will be described with reference to FIG. 8. The output specification 800 stores information regarding calculation processing and stores a sampling rate 801 and accuracy 802 (target accuracy) which is target accuracy of the calculation processing.

As illustrated in FIG. 9, the input port 706 stores a variable definition 900, a delivery source PID 901, and an input queue 902. The variable definition 900 stores a value input from a process model of a delivery source. The delivery source PID 901 stores information for identifying the process model of the delivery source. The input queue 902 stores information of a queue of data input from the process model of the delivery source.

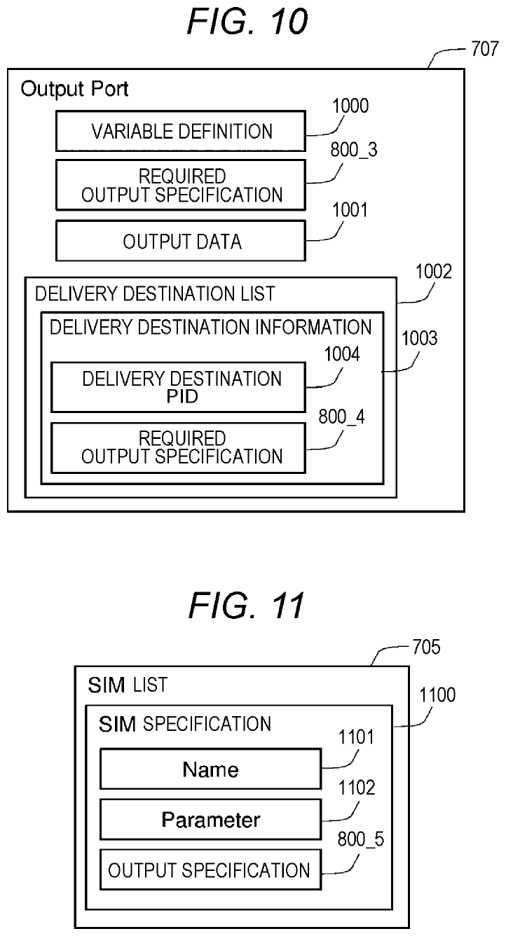

As illustrated in FIG. 10, the output port 707 stores a variable definition 1000, a required output specification 800_3, output data 1001, and a delivery destination list 1002. The variable definition 1000 stores a value to be output to a process model of a delivery destination. The required output specification 800_3 stores an output specification to be required for the process model of the delivery destination. The output data 1001 stores appropriate information to be output.

The delivery destination list 1002 is a list of the delivery destination information 1003. The delivery destination information 1003 stores the delivery destination PID 1004 and the required output specification 800_4. The delivery destination PID 1004 stores information for identifying the process model of the delivery destination, and the required output specification 800_4 stores an output specification to be required for this process model.

The SIM list 705 stores information of a simulation model to be handled by the process model specified by the PID 700. As illustrated in FIG. 11, the SIM list 705 stores a SIM specification 1100 which is information related to a specific specification of the simulation model. The SIM specification 1100 stores a name 1101, a parameter 1102, and an output specification 800_5. The name 1101 stores the name of the simulation model. The parameter 1102 stores parameters of the simulation model. The output specification 800_5 stores information of the output specification in execution of the simulation.

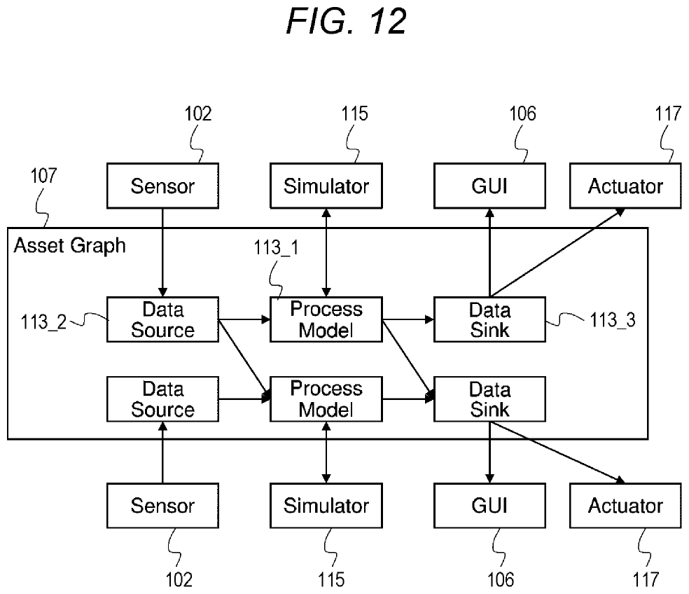

The process model has the above-described data structure as an example. Next, an example of outline of calculation processing according to a process model in execution of a simulation will be described with reference to FIG. 12. As illustrated in FIG. 12, sensor data is input from each sensor 102 to the asset graph 107. Then, the simulator 115 executes a simulation according to the information regarding a simulation model of a process model 113_1 and an output specification using an output value of a data source 113_2 based on the sensor data. Note that the data source 113_2 is allocated to each sensor 102.

As will be described in detail below, input and output of data related to required output specifications are appropriately performed from upstream and downstream. Then, the output specification of the process model is updated as appropriate.

A data sink 113_3 synchronizes the execution results of the simulation based on the respective process models 113 and outputs the results to the GUI 106 (specifically, the display 205). The user can confirm the results of the simulation output from the data sink 113_3 via the GUI 106. Note that data regarding the results of the simulation may be output from the data sink 113_3 to the actuator 117. Then, the processor of the actuator 117 may control operation of the actuator 117 on the basis of the input data regarding the results of the simulation. Furthermore, in the example of FIG. 12, an example in which data is input from the sensor 102 has been described, but the actuator 117 may be used instead, and data may be acquired from the actuator 117.

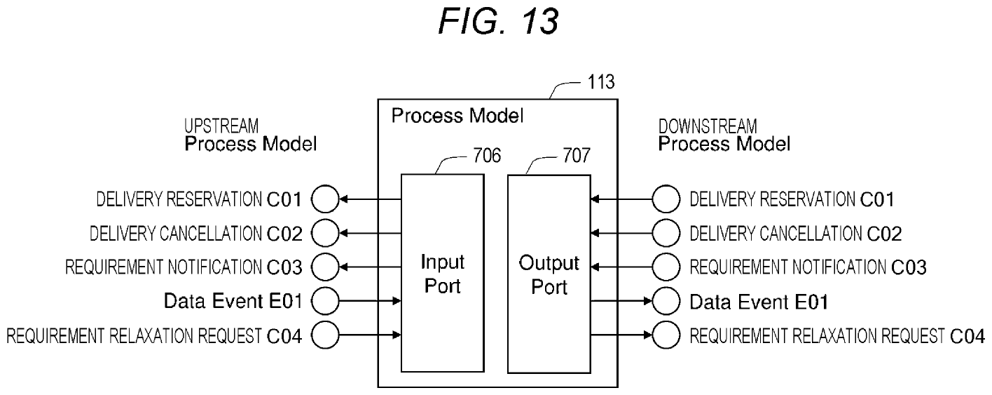

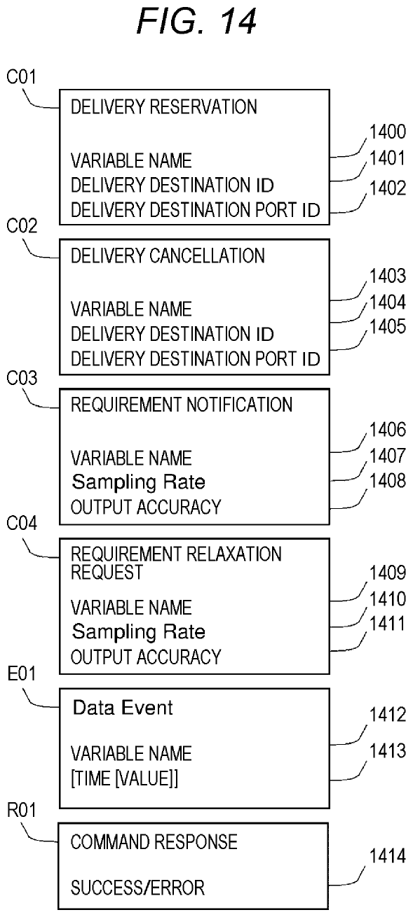

Next, an example of data to be input and output between process models will be described with reference to FIGS. 13 to 14.

As illustrated in FIG. 13, a data event E01 and a requirement relaxation request C04 are output from the output port 707 of the process model 113 associated with the upstream asset, and these pieces of data are input to the input port of the process model associated with the downstream asset. In addition, a delivery reservation C01, a delivery cancellation C02, and a requirement notification C03 are output from the output port of the process model associated with the downstream asset, and these pieces of data are input to the input port 706 of the process model 113 associated with the upstream asset.

As illustrated in FIG. 14, the delivery reservation C01 includes a variable name 1400, a delivery destination ID, and a delivery destination port ID in order to request data output on the upstream side. In addition, the delivery cancellation C02 includes a variable name 1403, a delivery destination ID 1404, and a delivery destination port ID 1405 in order to cancel the data output on the upstream side.

The requirement notification C03 includes a variable name 1406, a sampling rate 1407, and an output accuracy 1408 in order to require the output specification from the upstream side. The requirement relaxation request C04 includes a variable name 1409, a sampling rate 1410, and an output accuracy 1411 in order to request the downstream side to relax the output specification.

The data event E01 is output from upstream to downstream, and the data event E01 includes a variable name 1412 and a value 1413 at time. Note that data regarding a command response R01 may be input and output between the process models, and the command response R01 may include success/error information 1414.

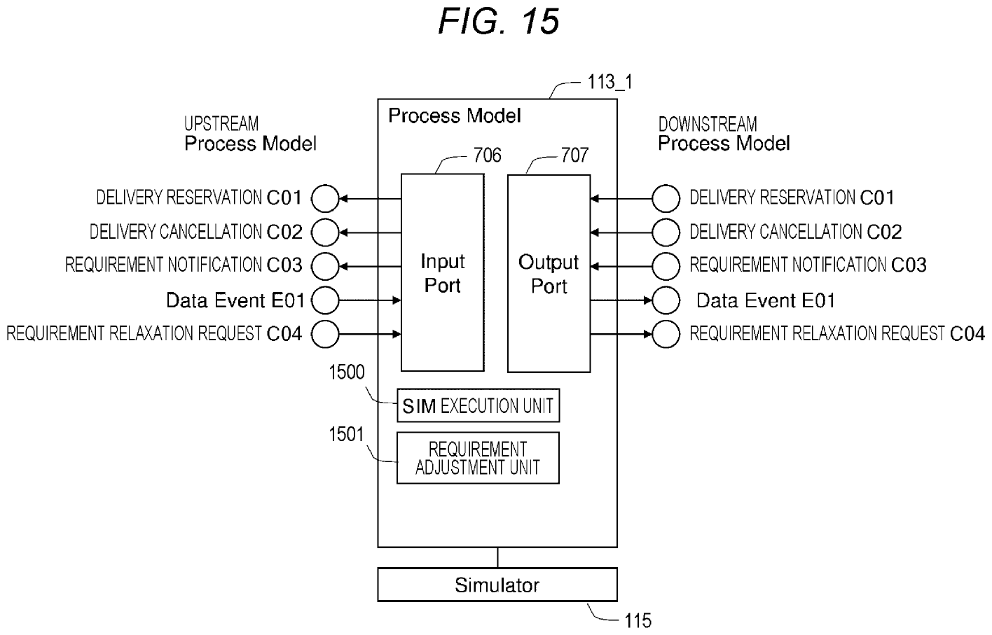

Next, adjustment of the output specification in the simulation will be described with reference to FIG. 15. The requirement adjustment unit 1501 adjusts the output specification (that is, the requirement relaxation request C04) on the basis of the output specification (that is, the sampling rate and accuracy) required from the upstream, input to the process model 113_1. In addition, the requirement adjustment unit 1501 adjusts the output specification on the basis of the output specification (that is, the requirement notification C03) required from the downstream, input to the process model 113_1. Then, an SIM execution unit 1500 executes a simulation with the output specification adjusted by the requirement adjustment unit 1501 on the basis of the input from the simulator 115. The output specifications related to the requirement relaxation request C04 and the requirement notification C03 are calculated by a requirement condition calculation unit (not illustrated). Further, the requirement relaxation request C04 and the requirement notification C03 in the process model are executed by a control unit (not illustrated).

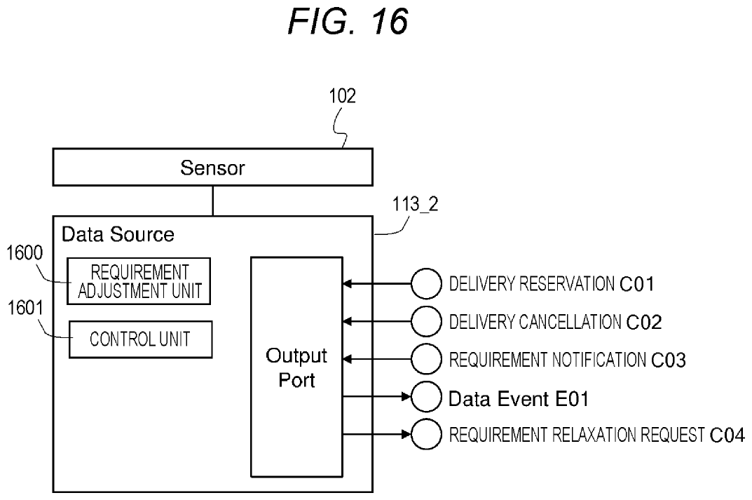

In addition, the delivery reservation C01, the delivery cancellation C02, and the requirement notification C03 may be input from the process model to which the data source 113_2 outputs data. In addition, the data event E01 and the requirement relaxation request C04 may be output to the process model. The data source 113_2 may also perform processing of adjusting a calculation load and relaxing the output specification. Next, an example of input/output control in the data source 113_2 will be described with reference to FIG. 16. Although not illustrated in FIG. 16, an input port to which the delivery reservation C01, the delivery cancellation C02, and the requirement notification C03 are to be input may be stored.

The requirement adjustment unit 1600 receives the requirement notification C03 from the process model associated with the downstream asset to which the data of the sensor 102 is to be input. Then, the requirement adjustment unit 1600 adjusts the output specification in the data source on the basis of the requirement notification C03. Then, the control unit 1601 performs processing of acquiring sensor data from the sensor 102 and outputting the sensor data on the basis of the adjusted output specification. In addition, the control unit 1601 outputs the requirement relaxation request C04 downstream.

In addition, the delivery reservation C01, the delivery cancellation C02, and the requirement notification C03 may be input from the data sink 113_3 to the process model that outputs data to the data sink 113_3.

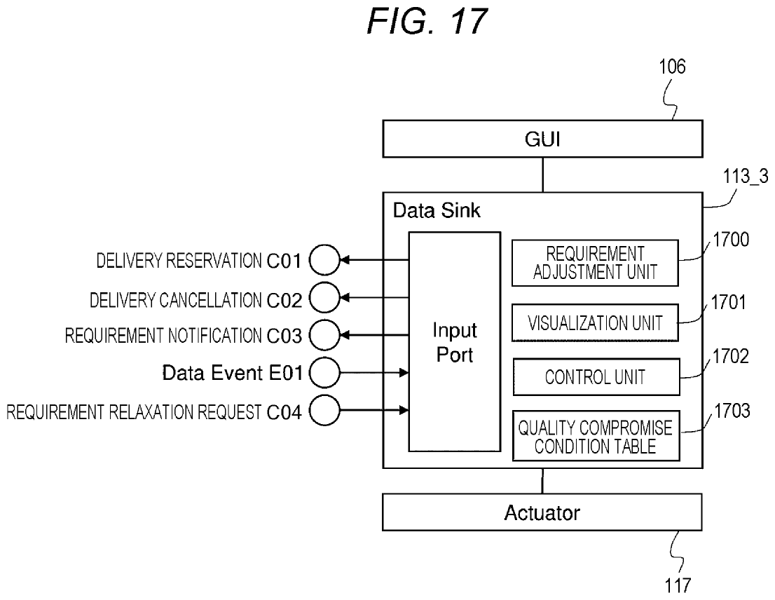

Furthermore, the data event E01 and the requirement relaxation request C04 may be output from the process model to the data sink 113_3. Also in the data sink 113_3, processing of adjusting a calculation load and relaxing the output specification may be performed. Next, an example of input/output control in the data sink 113_3 will be described with reference to FIG. 17. Although not illustrated, an output port from which the delivery reservation C01, the delivery cancellation C02, and the requirement notification C03 are to be output may be stored.

The requirement adjustment unit 1700 receives the requirement relaxation request C04 from the process model associated with the upstream asset. Then, the requirement adjustment unit 1700 adjusts the output specification in the data sink on the basis of the requirement relaxation request C04. Then, the control unit 1702 performs processing on the basis of the adjusted output specification.

Note that a visualization unit 1701 generates data to be output to the GUI 106 (specifically, the display 205) on the basis of the simulation result. An example of an aspect of a display screen will be described in detail later. In addition, the control unit 1702 outputs the requirement notification C03 related to the requirement of the output specification to the upstream process model on the basis of a quality compromise condition table 1703. The processing using the quality compromise condition table 1703 will be described later in detail.

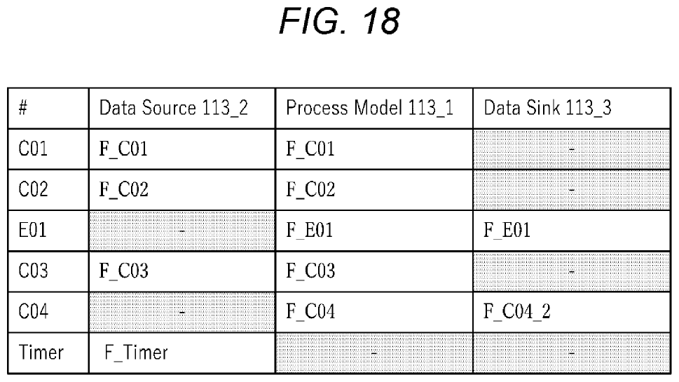

Next, an example of data input/output processing in the process model 113_1, the data source 113_2, and the data sink 113_3 will be described with reference to FIG. 18. Concerning processing (F_C01) relates to the output of the delivery reservation C01, in this example, the delivery reservation C01 is output from the process model 113_1 to the data source 113_2. Processing (F_C02) relates to output of the delivery cancellation C02, and in this example, the delivery cancellation C02 is output from the process model 113_1 to the data source 113_2. Processing (F_E01) relates to output of the data event E01, and in this example, the data event E01 is output from the process model 113_1 to the data sink 113_3. Processing (F_C03) relates to output of the requirement notification C03, and in this example, the requirement notification C03 is output from the process model 113_1 to the data source 113_2. Processing (F_C04, F_C04_2) relates to output of the requirement relaxation request C04 and output of the requirement notification C3. In this example, the requirement relaxation request C04 is output from the process model 113_1 to the data sink 113_3, and the requirement notification C3 is output from the data sink 113_3 to the process model 113_1. Processing (F Timer) relates to processing of outputting sensor data from the data source 113_2 to the process model 113_1.

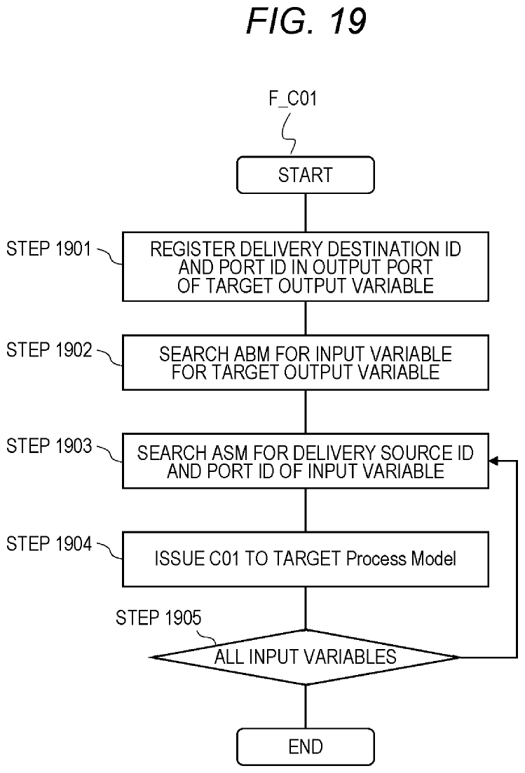

Next, details of each processing illustrated in FIG. 18 will be described with reference to FIGS. 19 to 27. Note that the subject of the processing is a processor (for example, the CPU 203).

First, an example (F_C01) of processing of outputting the delivery reservation C01 will be described in detail with reference to FIG. 19. As illustrated in FIG. 19, the CPU 203 registers a delivery destination ID and a port ID in the output port of a target output variable (STEP 1901). Next, the CPU 203 searches the ABM 111 for an input variable for the target output variable (STEP 1902).

Then, the CPU 203 searches the ASM 110 for a delivery source ID and a port ID of the input variable (STEP 1903) and issues the delivery reservation C01 to a target process model (STEP 1904). The CPU 203 repeats the processing until all the input variables are processed (STEP 1905).

Note that in a case where the processing of issuing the delivery reservation C01 from the process model 113_1 to the data source 113_2 is performed, and in a case where the processing of issuing the delivery reservation C01 from the data sink 113_3 to the process model 113_1 is performed, the CPU 203 performs similar processing.

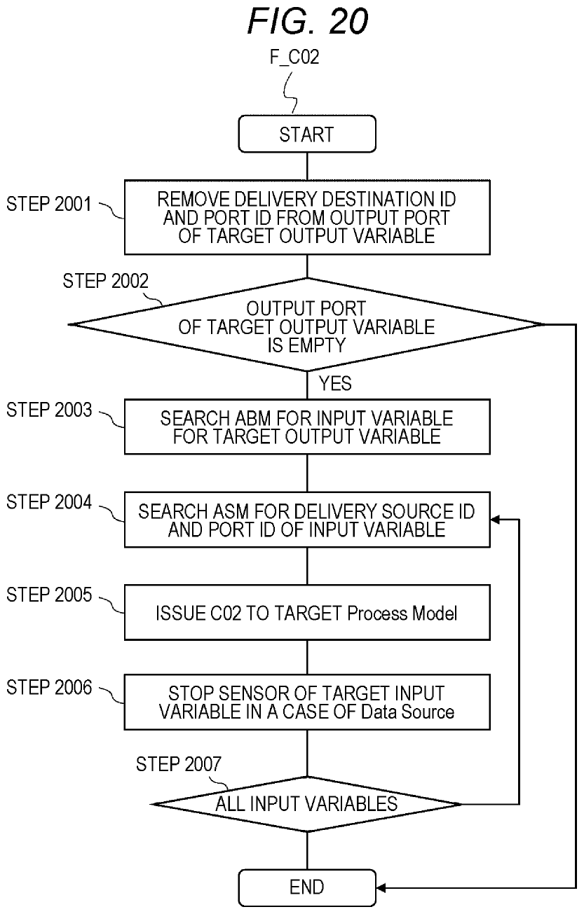

Next, an example (F_C02) of processing of outputting the delivery cancellation C02 will be described in detail with reference to FIG. 20. As illustrated in FIG. 20, the CPU 203 removes the delivery destination ID and the port ID from the output port of the target output variable (STEP 2001). Then, the CPU 203 determines whether the output port of the target output variable is empty (STEP 2002). In a case where it is determined that the target output variable is empty (STEP 2002: Yes), the processing proceeds to STEP 2003, otherwise the processing ends. The CPU 203 searches the ABM 111 for the input variable for the target output variable (STEP 2003).

The CPU 203 searches the ASM 110 for the delivery source ID and the port ID of the input variable (STEP 2004) and issues the delivery cancellation C02 to the target process model (STEP 2005). Then, the CPU 203 repeats the processing until all the variable inputs are processed (STEP 2007).

Note that in a case where the processing of issuing the delivery cancellation C02 from the process model 113_1 to the data source 113_2 is performed, and in a case where the processing of issuing the delivery cancellation C02 from the data sink 113 to the process model 113_1 is performed, the CPU 203 performs similar processing. Then, in a case where the delivery cancellation C02 is issued to the data source, input of the sensor data related to the target input variable is stopped (S2006).

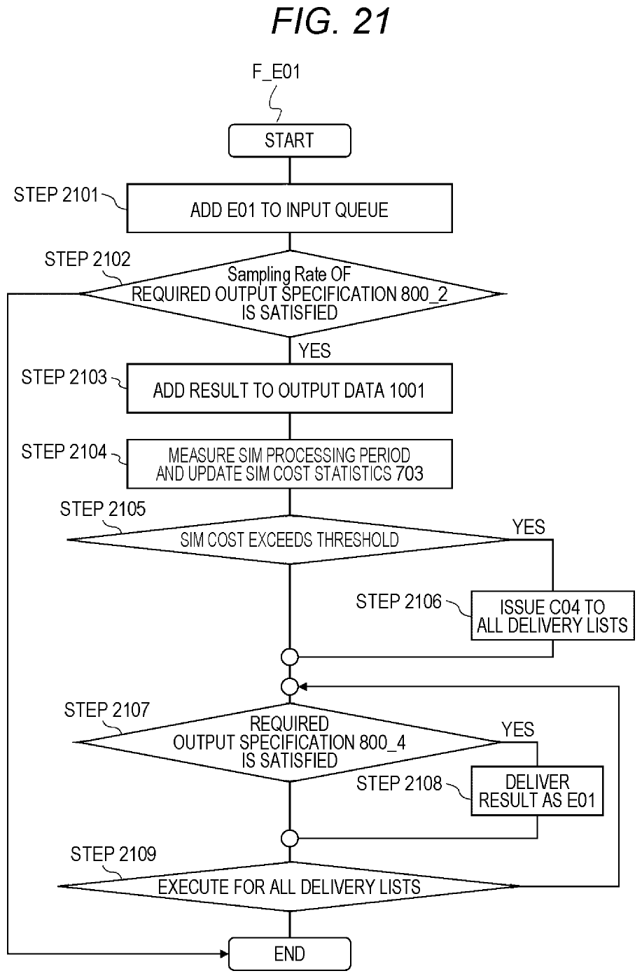

Next, an example of processing (F_E01) of outputting the data event E01 will be described in detail with reference to FIG. 21. As illustrated in FIG. 21, the CPU 203 adds the data event E01 to be output to the input queue. Next, the CPU 203 determines whether the required output specification 800_2 (in this example, the sampling rate) is satisfied (STEP 2102), and in a case where the required output specification 800_2 is satisfied, adds the result to the output data 1001 (STEP 2103).

The CPU 203 measures a simulation processing period and updates the SIM cost statistics 703 (STEP 2104). Further, the CPU 203 determines whether the SIM cost exceeds a threshold (STEP 2105), and in a case where it is determined that the SIM cost exceeds the threshold, issues the requirement relaxation request C04 to all the delivery lists (STEP 2106).

Further, the CPU 203 determines whether the required output specification 800_4 is satisfied (STEP 2107), and in a case where the required output specification 800_4 is satisfied, the result of the simulation is delivered as the data event E01 (STEP 2108). The CPU 203 executes this processing on all the delivery lists (STEP 2109).

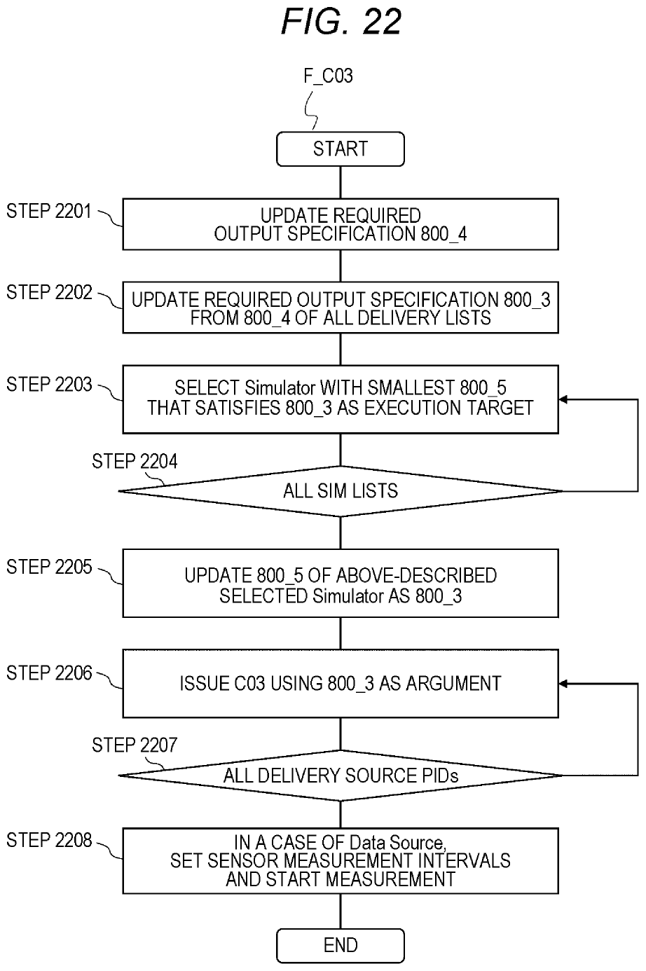

Next, an example of the processing (F_C03) of outputting the requirement notification C03 will be described in detail with reference to FIG. 22. As illustrated in FIG. 22, the CPU 203 updates the required output specification 800_4 (STEP 2201). Next, the CPU 203 updates the required output specification 800_3 from the required output specification 800_4 of the entire delivery list at the output port (STEP 2202). Next, the CPU 203 selects a simulator having the smallest output specification 800_5 satisfying the required output specification 800_3 as an execution target (STEP 2203). The CPU 203 repeats the processing of STEP 2203 for all the SIM lists (STEP 2204).

The CPU 203 updates the output specification 800_5 of the selected simulator as the required output specification 800_3 (STEP 2205). The CPU 203 issues the requirement notification C03 using the required output specification 800_3 as an argument (STEP 2206). The CPU 203 repeats the processing of STEP 2206 for all the delivery source PIDs (STEP 2207).

Note that in a case where the processing of issuing the requirement notification C03 from the process model 113_1 to the data source 113_2 is performed, the CPU 203 similarly issues the requirement notification C3 using the required output specification 800_3 as an argument. Then, in a case where the requirement notification C3 is issued to the data source, a sensor measurement period is set using the output specification based on the requirement notification C03, and the measurement starts (STEP 2208).

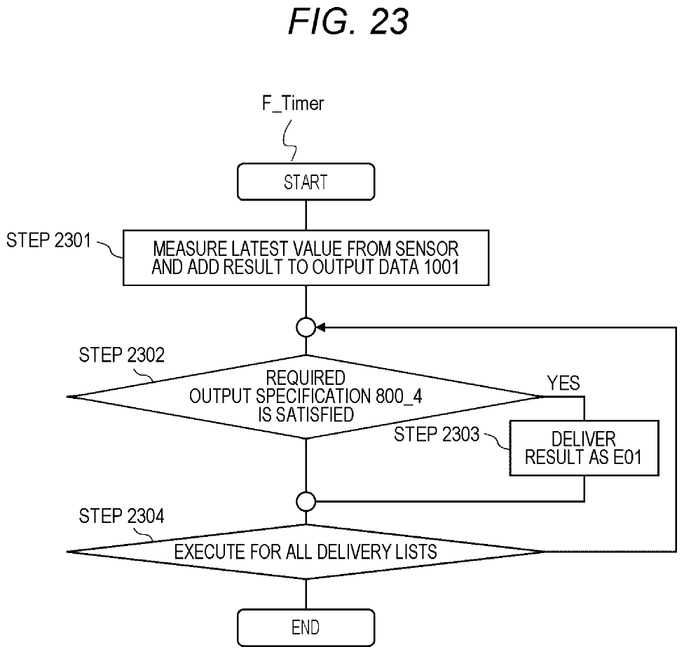

Next, an example of processing of outputting sensor data (F Timer) will be described in detail with reference to FIG. 23. As illustrated in FIG. 23, the CPU 203 (in other words, a control unit 1601) measures the latest value from the sensor and adds the result to the output data 1001 (STEP 2301). Next, the CPU 203 determines whether the required output specification 800_4 is satisfied (STEP 2302), and in a case where the required output specification is satisfied, delivers the result as the data event E01 (STEP 2203). The CPU 203 performs processing related to STEP 2302 and STEP 2303 on all the delivery lists (STEP 2304).

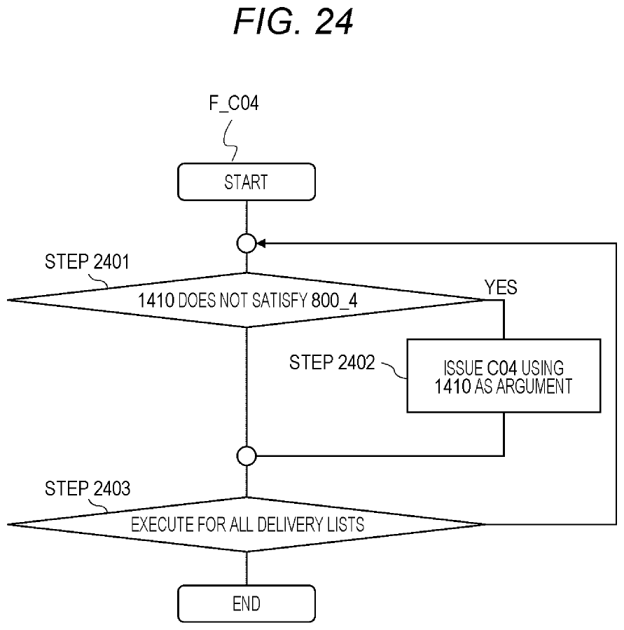

Next, an example of the processing (F_C04) of outputting the requirement relaxation request C04 will be described in detail with reference to FIG. 24. As illustrated in FIG. 24, the CPU 203 determines whether a sampling rate 1410 satisfies the required output specification 800_4 (STEP 2401). In a case where it is determined that the required output specification 800_4 is not satisfied, the CPU 203 issues the requirement relaxation request C04 using the sampling rate 1410 as an argument (STEP 2402). The CPU 203 repeats the processing related to STEP 2401 and STEP 2402 for all the delivery lists (STEP 2403).

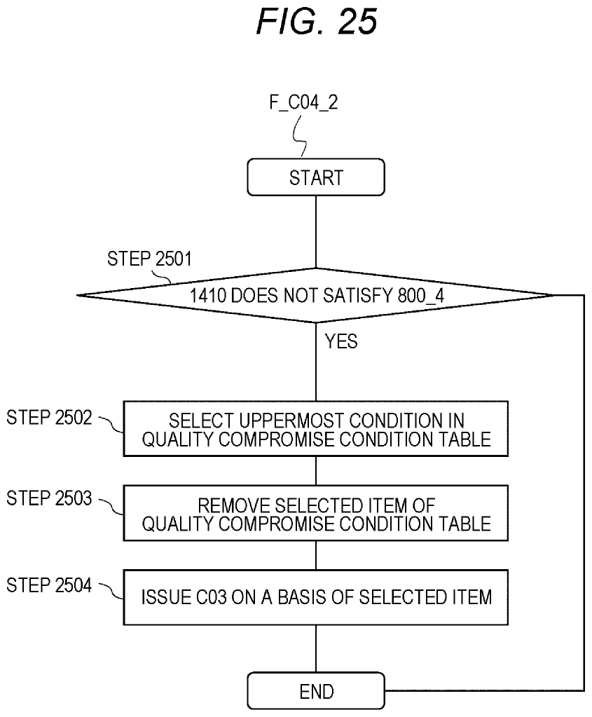

Next, an example of the processing (F_C04_2) of outputting the requirement notification C3 will be described in detail with reference to FIG. 25. As illustrated in FIG. 25, the CPU 203 determines whether the sampling rate 1410 satisfies the required output specification 800_4 (STEP 2501). In a case where it is determined that the required output specification 800_4 is not satisfied, the CPU 203 selects the uppermost condition in the quality compromise condition table 1703 (STEP 2502) and removes the selected item in the quality compromise condition table 1703 (STEP 2503). Then, the CPU 203 issues the requirement notification C3 on the basis of the appropriately selected item (for example, the next item of the removed selected item) in the quality compromise condition table 1703 (STEP 2504).

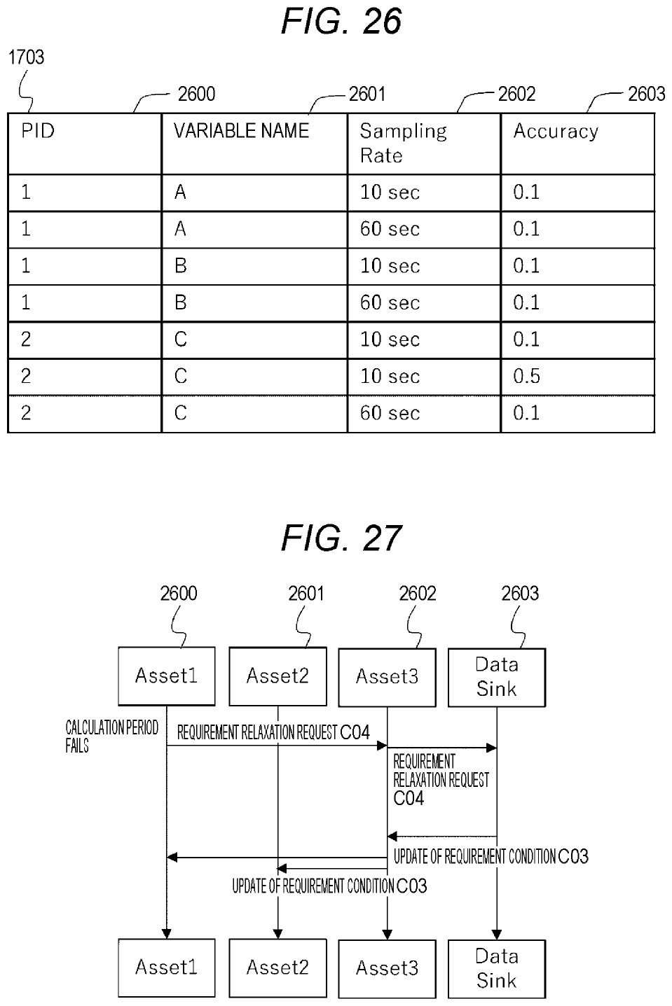

Here, an example of the data structure of the quality compromise condition table used in the processing (F_C04_2) will be described with reference to FIG. 26. As illustrated in FIG. 26, the quality compromise condition table 1703 stores a PID 2600, a variable name 2601, a sampling rate 2602, and accuracy 2603.

Next, an example of processing of changing the output specification will be described with reference to FIG. 27. In this example, an asset 2600, an asset 2601, an asset 2602, and a data sink 2603 are connected from the upstream side.

As illustrated in FIG. 27, in a case where a calculation period related to the asset 2600 fails in the simulation (that is, in a case where the calculation resource is insufficient with respect to the calculation cost), the requirement relaxation request C04 is issued from the process model of the upstream asset 2600 to the process model of the downstream asset 2602. Further, the requirement adjustment unit adjusts the output specification in the process model of the asset 2602 on the basis of the output specification of the requirement relaxation request C04, and the requirement condition calculation unit calculates a requirement (required output specification) on the basis of the adjusted output specification. Then, the control unit outputs the requirement relaxation request C04 from the process model of the asset 2602 to the data sink 2603.

The quality compromise condition table of the data sink 2603 is referred to, the requirement notification C3 satisfying the quality is output to the process model of the asset 2602, and the requirement adjustment unit updates the requirement condition of the output specification. In addition, the requirement condition calculation unit calculates the requirement condition on the basis of the adjusted (updated) output specification. Then, the control unit outputs the requirement notification C3 to the process model of the asset 2600 and the process model of the asset 2601, and the requirement adjustment unit similarly updates the requirement conditions of the output specification for the asset 2600 and the asset 2601.

In this processing, the requirement condition calculation unit calculates a requirement condition (output specification) that does not cause a failure in the calculation period (that is, the calculation resources are not insufficient in the simulation) from the calculation amount actual result in the simulation, and the control unit outputs the requirement condition as the requirement notification C3 and the requirement relaxation request C4.

Thus, by changing the output specification according to the requirement relaxation request C04 from the upstream side and changing the output specification according to the requirement notification C03 from the downstream side, the output specification can be adjusted automatically or at low cost, so that the calculation load as a whole can be reduced. For example, through this processing, an asset having a large time constant (for example, an asset that is considered to change gently, such as an oil temperature and an oil deterioration degree in an air compressor) is adjusted so as not to be predicted at a high sampling rate (for example, in order not to predict in units of seconds). On the other hand, by setting the output specification that guarantees the quality in the quality compromise condition table, it is possible to improve quality of the simulation result.

Note that the output specification may be calculated from, for example, domain knowledge, simulation ability, and a time constant obtained from the simulation result. For example, in a case of an oil deterioration degree in an air compressor as described above, the sampling rate in units of day may be specified from the domain name related to the “oil deterioration degree”. In addition, as the simulation ability, the output specification may be calculated on the basis of a calculation execution period in a simulation. For example, in a simulation in which calculation is executed on a daily basis, a sampling rate on a daily basis may be specified. Furthermore, the sampling rate may be specified according to a time constant based on the simulation result.

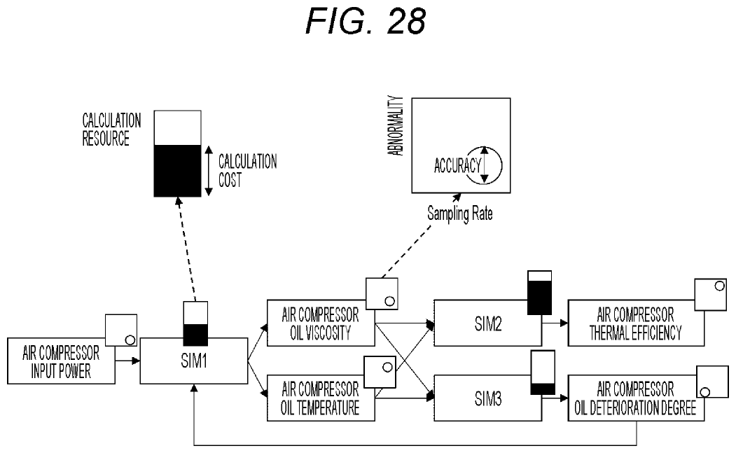

Next, an example of an image to be output to the GUI will be described with reference to FIG. 28. In this example, an asset of air compressor input power, an asset of air compressor oil viscosity and an asset of an air compressor oil temperature, an asset of air compressor thermal efficiency and an asset of an air compressor oil deterioration degree are connected from the upstream side.

As illustrated in FIG. 28, in the SIM 1, a simulation using a parameter from the air compressor input power and a parameter from the air compressor oil deterioration degree as inputs is executed according to the process model of the air compressor oil viscosity and the process model of the air compressor oil temperature, and the results are output. In addition, in the SIM2 and the SIM3, a simulation using parameters from the air compressor oil viscosity and the air compressor oil temperature as inputs is executed according to the process model of the air compressor thermal efficiency and the process model of the air compressor oil deterioration degree, and the results are output.

Then, an image indicating a calculation resource and calculation cost is displayed as the information regarding the SIM 1 to 3. Thus, an occupancy of the calculation period in the simulation is visualized, and the calculation cost in the simulation can be confirmed by confirming this information. In addition, an image indicating a simulation result (abnormality) regarding each asset is displayed, and in the present embodiment, an image of a graph in which the abnormality and the sampling rate are associated with each other is displayed. In this example, a circle whose diameter indicates accuracy is displayed around the position of the result of the simulation. Thus, a range of an error of the simulation result can be confirmed by confirming the circle. Note that the user may input an adjustment value such as a sampling rate on the basis of the visualized data and adjust the sampling rate, or the like, in each simulation.

Furthermore, the calculation system may calculate a charge amount for using a digital twin service on the basis of a difference between a current simulation interval (that is, the sampling rate) and accuracy (target accuracy) and a simulation interval and accuracy required by the user by a charge amount calculation unit (program not illustrated included in the calculation system). Here, the charge amount increases as the simulation interval and accuracy required by the user increase and the difference from the current simulation interval and accuracy increases. Furthermore, in a case where the user requires the simulation interval or the accuracy, the charge amount may be output to the GUI.

Note that screen output to the GUI (specifically, the display 205) described above is performed by execution of a display unit (program not illustrated included in the calculation system).

Although the embodiment of the present invention has been described in detail above, the present invention is not limited to the above embodiment, and various design changes can be made without departing from the spirit of the present invention described in the claims. For example, the above-described embodiment has been described in detail for easy understanding of the present invention, and the present invention is not necessarily limited to those having all the described configurations. In addition, part of the components of a certain embodiment can be replaced with the components of another embodiment, and the components of another embodiment can be added to the configuration of a certain embodiment. In addition, it is possible to make addition, deletion, and replacement concerning part of the components of each embodiment.

What is claimed is:

1. A calculation system that, in an environment based on a digital twin to which assets are hierarchically connected, executes a simulation regarding the assets on a basis of an output specification regarding a sampling rate and target accuracy that is target accuracy of calculation processing, the calculation system comprising:
a requirement condition calculation unit configured to calculate an output specification to be required for a downstream hierarchy; and
a requirement adjustment unit configured to adjust an output specification of a hierarchy that receives a requirement on a basis of the requirement received from the downstream hierarchy,
wherein
the requirement condition calculation unit calculates an output specification to be required for an upstream hierarchy on a basis of the output specification adjusted by the requirement adjustment unit.

2. The calculation system according to claim 1, wherein
the requirement condition calculation unit calculates an output specification on a basis of any one of domain knowledge of the assets, an execution period of calculation in the simulation, and a time constant based on a simulation result.

3. The calculation system according to claim 1, wherein
the requirement condition calculation unit calculates an output specification in which a calculation resource is not insufficient in the simulation on a basis of an actual result of a calculation amount in the simulation.

4. The calculation system according to claim 1, further comprising:
a charge amount calculation unit configured to calculate a charge amount for using a digital twin service on a basis of a difference between a current output specification for the simulation and an output specification required by a user.

5. The calculation system according to claim 1, further comprising:
a display unit configured to display an image indicating a calculation resource and calculation cost in the simulation and an image indicating a simulation result regarding each of the assets.

6. A calculation method for, in an environment based on a digital twin to which assets are hierarchically connected, executing a simulation regarding the assets on a basis of an output specification regarding a sampling rate and target accuracy that is target accuracy of calculation processing, the calculation method being executed using a processor and a storage that stores an output specification,
the calculation method comprising:
by the processor,
calculating an output specification to be required for a downstream hierarchy;
adjusting an output specification of a hierarchy that receives a requirement on a basis of the requirement received from the downstream hierarchy; and
calculating an output specification to be required for an upstream hierarchy on a basis of the adjusted output specification.

7. The calculation method according to claim 6, further comprising:
by the processor,
calculating an output specification on a basis of any one of domain knowledge of the assets, an execution period of calculation in the simulation, and a time constant based on a simulation result.

8. The calculation method according to claim 6, further comprising:
by the processor,
calculating an output specification in which a calculation resource is not insufficient in the simulation on a basis of an actual result of a calculation amount in the simulation.

9. The calculation method according to claim 6, further comprising:
by the processor,
calculating a charge amount for using a digital twin service on a basis of a difference between a current output specification for the simulation and an output specification required by a user.

10. The calculation method according to claim 6, further comprising:
by the processor,
outputting to a display, data for displaying an image indicating a calculation resource and calculation cost in the simulation and data for displaying an image indicating a simulation result regarding each of the assets.
